(19) United States
(12) Patent Application Publication
(10) Pub. No.: US 2026/0163720 A1
(43) Pub. Date: Jun. 11, 2026

(54) METHOD FOR PRIVACY PROTECTION OF SMART CONTRACT, ELECTRONIC DEVICE AND COMPUTER PROGRAM PRODUCT

(71) Applicant: HANGZHOU HIGH-TECH ZONE (BINJIANG) INSTITUTE OF BLOCKCHAIN AND DATA SECURITY, Hangzhou City (CN)

(72) Inventors: Hao DUAN, Hangzhou City (CN); Xiaojing LI, Hangzhou City (CN); Xiangjuan JIA, Hangzhou City (CN); Chao YUAN, Hangzhou City (CN); Qi HE, Hangzhou City (CN); Yiming LU, Hangzhou City (CN); Yaqing QI, Hangzhou City (CN)

(21) Appl. No.: 19/410,559

(22) Filed: Dec. 5, 2025

(30) Foreign Application Priority Data
Dec. 6, 2024 (CN) 202411783033.8

(51) Int. Cl. H04L 9/06; H04L 9/00

(52) U.S. Cl. CPC H04L 9/0618; H04L 9/50

(57) ABSTRACT

A method for privacy protection of smart contract includes: obtaining a variable identifier, a privacy-trigger sub-script, and ciphertexts of a plurality of privacy-trigger sub-scripts of other participating users input by the user intending to perform a transaction in response to a transaction instruction; determining a target state variable corresponding to the variable identifier from the smart contract, and obtaining a precomputed ciphertext corresponding to the target state variable; computing, using the preset digest algorithm, based on the plurality of privacy-trigger sub-scripts and the ciphertexts of the plurality of privacy-trigger sub-scripts to obtain the target ciphertext; executing a decision-making script bytecode in the privacy-trigger sub-script to obtain an execution result if the target ciphertext is identical to the precomputed ciphertext; and performing a predetermined operation on the target state variable when the execution result indicates execution success. The method significantly enhances the level of privacy and security of the smart contract.

### CROSS-REFERENCE TO RELATED APPLICATIONS

This application claims priority to Chinese patent application No. 202411783033.8, filed on Dec. 6, 2024, and entitled “method and apparatus for privacy protection of smart contract, electronic device and program product”, the entire contents of which are incorporated herein by reference.

### TECHNICAL FIELD

The present disclosure pertains to the field of blockchain technologies, and more particularly, to a method and an apparatus for privacy protection of a smart contract, an electronic device and a program product.

### BACKGROUND

Currently, smart contract technologies on the blockchain are completely open and public, which is mainly reflected in the openness of contract business logic and target state variables, thereby results in full openness of account behaviors operated by smart contracts. Thus, user privacy cannot be guaranteed.

Conventional technologies generally utilize consortium blockchain technology, which prevents participants other than consortium blockchain nodes from directly accessing contract status information. However, data of smart contracts remains completely open for the participants of the consortium blockchain nodes. It is obvious that the conventional technologies cannot meet the practical requirement, because that the conventional technologies not only have narrow scope of application, but also weaken the privacy and the security of smart contracts.

### SUMMARY

The embodiments of the present disclosure provide a method and an apparatus for privacy protection of a smart contract, an electronic device, and a program product, which aim at addressing the problem in the related art that the conventional technologies cannot meet the practical requirement, have a narrow scope of application, and weakens the privacy and the security of smart contracts.

In accordance with the first aspect, a method for privacy protection of a smart contract implemented by a node device within a blockchain is provided in the embodiments of the present disclosure. The method includes:
obtaining, in response to receiving a transaction instruction from a user intending to perform a transaction, a variable identifier, a privacy-trigger sub-script, and ciphertexts of a plurality of privacy-trigger sub-scripts of other participating users input by the user intending to perform a transaction; the privacy-trigger sub-script is used for unlocking a corresponding state variable in the smart contract;
determining a target state variable corresponding to the variable identifier in the smart contract, and obtaining a precomputed ciphertext corresponding to the target state variable; wherein the precomputed ciphertext is calculated by using a preset digest algorithm;
computing, using the preset digest algorithm, based on the plurality of privacy-trigger sub-scripts and the ciphertexts of the plurality of privacy-trigger sub-scripts to obtain the target ciphertext;
executing, in accordance with a determination that the target ciphertext is identical to the precomputed ciphertext, a decision-making script bytecode in the privacy-trigger sub-script to obtain an execution result; the decision-making script bytecode is used to determine whether the target state variable can be unlocked; and
performing a predetermined operation on the target state variable in accordance with a determination that the execution result indicates execution success.

In some embodiments, said obtaining the precomputed ciphertext corresponding to the target state variable includes:
determining a target state of the target state variable; and
obtaining the precomputed ciphertext in accordance with a determination that the target state is a locked state.

In some embodiments, performing ciphertext computation using the preset digest algorithm includes the following operations:
obtaining a callback function signature corresponding to the target state variable from a storage of the node device;
computing, using the preset digest algorithm, based on the callback function signature and the privacy-trigger sub-script respectively to obtain a first ciphertext corresponding to the callback function signature and a second ciphertext corresponding to the privacy-trigger sub-script; and
computing, using the preset digest algorithm, based on the first ciphertext, the second ciphertext, and the ciphertexts of the plurality of privacy-trigger sub-scripts to obtain the target ciphertext.

In some embodiments, the privacy-trigger sub-script includes callback method parameters; said performing the predetermined operation on the target state variable includes:
obtaining a callback function signature corresponding to the target state variable from the storage of the node device;
controlling a smart contract execution engine to determine a target call method matching the callback function signature in the smart contract; and
controlling the smart contract execution engine to execute the target callback method according to the callback method parameters to implement performing the predetermined operation on the target state variable.

In some embodiments, before said obtaining, in response to receiving the transaction instruction from the user intending to perform a transaction, the variable identifier, the privacy-trigger sub-script, and the ciphertexts of the plurality of privacy-trigger sub-scripts of other participating users input by the user intending to perform a transaction, the method further includes:
determining a current state of the target state variable in response to receiving a locking instruction from an owner of the target state variable;
outputting a prompt message indicating that the target state variable cannot be locked again, in accordance with a determination that the current state of the target state variable is a locked state; or alternatively,
locking the target state variable in accordance with a determination that the current state of the target state variable is an unlocked state.

In some embodiments, said locking the target state variable includes:
obtaining preset decision-making script bytecode(s) and preset callback method parameters corresponding to a plurality of participating users;
generating the privacy-trigger sub-scripts for the plurality of participating users based on the preset decision-making script bytecode(s) and the preset callback method parameters corresponding to the plurality of participating users;
computing, using the preset digest algorithm, based on the callback function signature corresponding to the target state variable and the privacy-trigger sub-scripts of the plurality of participating users respectively, to obtain the third ciphertext corresponding to the callback function signature and the ciphertexts of the privacy-trigger sub-scripts of the plurality of participating user;
computing, using the preset digest algorithm, based on the third ciphertext and the ciphertexts of the privacy-trigger sub-scripts of the plurality of participating users to obtain the precomputed ciphertext; and
locking the target state variable based on the precomputed ciphertext.

In some embodiments, after said locking the target state variable based on the precomputed ciphertext, the method further includes:
sending, for any participating user, the privacy-trigger sub-script of the participating user and the ciphertexts of the privacy-trigger sub-scripts corresponding to other participating users to a terminal device of the participating user. Said other participating users refer to all other users except the participating user among the plurality of participating users.

In accordance with the second aspect, an electronic device is provided in the embodiments of the present disclosure. The electronic device includes a processor, a storage, and a computer program stored in the storage and executable by the processor. The processor is configured to, when executing the computer program, cause the electronic device to implement any method for privacy protection of the smart contract in the first aspect.

In accordance with the third aspect, a non-transitory computer-readable storage medium is provided in the embodiments of the present disclosure. The non-transitory computer-readable storage medium stores a computer program, that, when executed by a processor of an electronic device, causes the processor of the electronic device to implement any method for privacy protection of the smart contract in the first aspect.

In accordance with the fourth aspect, a computer program product is provided in the embodiments of the present disclosure. When the computer program product is executed by the electronic device, the electronic device is caused to implement any method for privacy protection of the smart contract in the first aspect.

The embodiments of the present disclosure involve the following beneficial effects over the related art:

The method for privacy protection of the smart contract provided in the embodiments of the present disclosure includes following operations: determining the target state variable corresponding to the variable identifier from the smart contract, and obtaining the precomputed ciphertext corresponding to the target state variable; computing, using the preset digest algorithm, based on the plurality of privacy-trigger sub-scripts and the ciphertexts of the plurality of privacy-trigger sub-scripts to obtain the target ciphertext; executing a decision-making script bytecode in the privacy-trigger sub-script to obtain an execution result, in accordance with a determination that the target ciphertext is identical to the precomputed ciphertext; and performing a predetermined operation on the target state variable in accordance with a determination that the execution result indicates execution success. As compared to the existing technologies, in the present disclosure, the corresponding operation is performed on a certain state variable of the smart contract only when the privacy-trigger sub-script of user intending to perform a transaction and the ciphertexts of the privacy-trigger sub-scripts of other participating users meet the requirements, that is, the privacy-trigger sub-script of the user intending to perform a transaction and the ciphertexts of the privacy-trigger sub-scripts of other participating users are legitimate. This method avoids an illegitimate operation carried out by an illegitimate participant and enhances the security of the smart contract. Additionally, in the present disclosure, when performing unlocking operation on the state variable, the privacy-trigger sub-script of the user intending to perform a transaction is only made public, while the privacy-trigger sub-scripts of other participating users are not made public, thus, the privacies of the other participating users are protected, and the privacy level of the smart contract is enhanced. Furthermore, the present disclosure is not limited to consortium chains, thus, the scope of application of the method for privacy protection of the smart contract is expanded.

### DESCRIPTION OF THE DRAWINGS

In order to describe the embodiments of the present disclosure more clearly, a brief introduction regarding the accompanying drawings that need to be used for describing the embodiments or the existing technologies is given below. It is obvious that the accompanying drawings described below are merely some embodiments of the present disclosure, a person of ordinary skill in the art may also acquire other drawings according to these drawings without paying creative works.

FIG. 1 is a flowchart illustrating implementation of a method for privacy protection of a smart contract provided in an embodiment of the present disclosure;

FIG. 2 is a flowchart illustrating the implementation of the method for privacy protection of the smart contract provided in another embodiment of the present disclosure;

FIG. 3 is a flowchart of the implementation of the method for privacy protection of the smart contract provided in another embodiment of the present disclosure; and

FIG. 4 is a schematic block diagram illustrating a structure of an electronic device provided in an embodiment of the present disclosure.

### DETAILED DESCRIPTION OF EMBODIMENTS

In the following descriptions, in order to describe but not intended to limit the present disclosure, concrete details including specific system structure and technique are proposed to facilitate a comprehensive understanding of the embodiments of the present disclosure. However, a person of ordinarily skill in the art should understand that, the present disclosure may also be implemented in some other embodiments without these concrete details. In other conditions, detailed explanations of method, device, circuit and system well known to the public are omitted, thus, unnecessary details may be avoided from disturbing the description of the present disclosure.

As used herein, when a term “comprise” is used in the description and annexed claims, the term “comprise/include” is intended to indicate existence of the described characteristics, integer, steps, operations, elements and/or components, but not exclude existence or adding of one or more other characteristics, integer, steps, operations, elements, components and/or combination thereof.

It should be further understood that, terms “and/or” used in the description and the annexed claims of the present disclosure are referred to as any combination of one or a plurality of listed item(s) associated with each other and all possible items, and including these combinations.

As is used in the description and the annexed claims, a term “if” may be interpreted as “when” or “once” or “in response to determination” or “in response to detection”. Similarly, terms such as “if it is determined that”, or “if it is detected that (a described condition or event)” may be interpreted as “once it is determined” or “in response to the determination” or “once it is detected that (the described condition or event)” or “in response to the detection (the described condition or event)”.

In addition, in the descriptions of the present disclosure, terms such as “first” and “second”, “third”, etc., are only used for distinguishing purpose in description, but shouldn't be interpreted as indication or implication of a relative importance.

The descriptions of “referring to one embodiment” or “referring to some embodiments”, or the like as described in the specification of the present disclosure means that a specific feature, structure, or characters which are described with reference to this embodiment are included in one embodiment or some embodiments of the present disclosure. Thus, the sentences including “in one embodiment”, “in some embodiments”, “in some other embodiments”, “in other embodiments” in this specification are not necessarily referring to the same embodiment, but instead indicate “one or more embodiments instead of all embodiments”, unless otherwise these sentences are specially emphasize in other manner. The terms of “comprising”, “including”, “having” and the variations thereof have the meaning of “including but is not limited to”, unless otherwise they are specially emphasized in other manner.

Currently, smart contract technologies on the blockchain are entirely open and transparent, and are mainly manifested in the public disclosure of contract business logic and state variables, this results in the complete public disclosure of account behaviors operated through smart contracts, user privacy cannot be guaranteed. For example, in a scenario related to digital assets, a user A locks an asset in a smart contract, his wife B is allowed to withdraw the asset at any time and his child C is also allowed to withdraw the asset after 12 months. In this case, regardless of whether the asset is ultimately withdrawn by the wife B or the child C, account information of the two individuals and the conditions for withdrawing the asset have already been made public, and a potential security risk is incurred.

The existing smart contract technologies may achieve issuance and transfer of digital assets, and may be deployed on a consortium chain to achieve a certain degree of data privacy. Although participants other than consortium chain nodes cannot directly access the contract status information through the consortium chain and permission control, for participants of the consortium chain nodes, data of the smart contract is still completely transparent. In addition, by tracing all transactions on the consortium chain, the state data of the smart contract may also be recovered to a certain extent.

Therefore, the present disclosure proposes a method for privacy protection of smart contract, this method can protect the privacies of other participating users when a user performs operation on one certain state variable within the smart contract. Moreover, this method may also enhance the security of the state variables by preventing the state variables from being operated by an illegitimate participant.

The method for privacy protection of the smart contract will be elaborated with reference to the embodiments below.

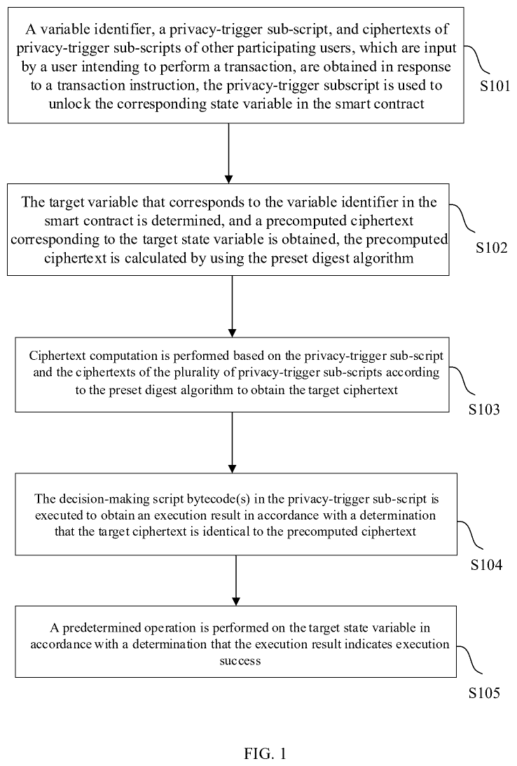

Referring to FIG. 1, FIG. 1 is a flowchart illustrating an implementation of the method for privacy protection of the smart contract provided in an embodiment of the present disclosure. In this embodiment of the present disclosure, an executive subject of the method for privacy protection of the smart contract is an electronic device. The electronic device is a node device in a blockchain.

As shown in FIG. 1, the method for privacy protection of the smart contract provided in an embodiment of the present disclosure may include steps S101-S105, which are described in detail as follows:

In the step of S101, a variable identifier, a privacy-trigger sub-script, and ciphertexts of privacy-trigger sub-scripts of other participating users, which are input by a user intending to perform a transaction, are obtained in response to receiving a transaction instruction from a user intending to perform a transaction. The privacy-trigger sub-script is used to unlock the corresponding state variable in the smart contract.

In this embodiment of the present disclosure, when the user intending to perform a transaction wants to perform a corresponding operation (e.g., digital asset transfer) on a certain state variable in the smart contract, the user may send a transaction instruction to the electronic device.

It should be noted that the transaction instruction carries the transaction information of the user intending to perform a transaction. The transaction information includes, but is not limited to, the variable identifiers, the privacy-trigger sub-scripts, and the ciphertexts of the privacy-trigger sub-scripts of other participating users.

The privacy-trigger sub-script are used to unlock the corresponding state variable in the smart contract.

The variable identifier may be a key value of the state variable.

In the embodiments of the present disclosure, the state variables specifically refer to the state variables that may be operated by the user within the logic of the smart contract, which include, but not limited to, a certain digital asset in the digital asset transaction scenario.

The privacy-trigger sub-scripts include, but are not limited to, decision-making script bytecode and callback method parameters.

The decision-making script bytecode refers to the conditional decision logic written in smart contract language, which is used to determine whether the corresponding state variable may be unlocked, that is, whether the condition for unlocking the state variable is met.

It should be noted that the decision-making script bytecode may be written according to the actual requirement, which is not limited herein.

Callback method parameters refer to the invocation parameters used to pass into the callback method. After determining that the script bytecode meets the condition, the smart contract execution engine may invoke the callback method through these callback method parameters to execute subsequent logic and perform corresponding operation on the state variables.

It should be noted that the callback method defines the processing logic after the state variable is unlocked.

In some possible embodiments, the privacy-trigger sub-script may further include a ciphertext corresponding to the privacy-trigger sub-script.

The aforesaid ciphertext may be obtained by calculating based on the decision-making script bytecode and the callback method parameters in the privacy-trigger sub-script using a preset digest algorithm.

In the embodiments of the present disclosure, the preset digest algorithm includes, but is not limited to, message-digest algorithm (Message-Digest Algorithm, MD5) and secure hash algorithm (Secure Hash Algorithm, SHA), etc.

In a practical application, an information digest algorithm is an algorithm that computes information of arbitrary length into a “fingerprint” or “message digest” having fixed length.

The secure hash algorithm is an algorithm that computes a string with fixed length (also known as message digest) corresponding to a digital message.

In this embodiment of the present disclosure, after detecting the aforesaid transaction instruction, the electronic device may extract transaction information from the instruction since the transaction instruction carries the transaction information input by the user intending to perform a transaction. Thus, the electronic device may extract the transaction information from the transaction instruction, thereby obtaining the variable identifier, the privacy-trigger sub-script, and the ciphertexts of the privacy-trigger sub-scripts for the other participating users, which are input by the user intending to perform a transaction.

It should be noted that the ciphertexts of the privacy-trigger sub-scripts for other participating users are also calculated using the preset digest algorithm.

In the step of S102, the target state variable that corresponds to the variable identifier in the smart contract is determined, and a precomputed ciphertext corresponding to the target state variable is obtained. The precomputed ciphertext is calculated by the preset digest algorithm.

In this embodiments of the present disclosure, after obtaining the variable identifier, the electronic device may determine the state variable (i.e., the target state variable) that requires to be operated (e.g., transaction) by the user intending to perform a transaction based on the variable identifier.

It should be noted that the electronic device has pre-stored the precomputed ciphertexts for each state variable in a locked state. Therefore, the electronic device may retrieve the precomputed ciphertext corresponding to the target state variable from the storage thereof. The precomputed ciphertext is calculated by the preset digest algorithm.

In one embodiment of the present disclosure, since only a state variable in the locked state is assigned with the corresponding precomputed ciphertext, in order to improve an operation efficiency, the electronic device may specifically obtain the precomputed ciphertext corresponding to the target state variable by performing the following steps which are described in detail as follows:
determining a target state of the target state variable;
obtaining the precomputed ciphertext in accordance with a determination that the target state is the locked state.

In this embodiment, the electronic device may detect the current target state of the target state variable. The target state includes, but is not limited to, a locked state and an unlocked state.

When the electronic device detects that the target state of the target state variable is the locked state, it indicates that the target state variable is indeed the state variable that the user intending to perform a transaction needs to operate on. Moreover, there exists a precomputed ciphertext corresponding to the target state variable, which means that the electronic device stores this precomputed ciphertext. Therefore, the electronic device can obtain the precomputed ciphertext corresponding to the target state variable.

In some possible embodiments, the electronic device may execute the smart contract through a smart contract execution engine, in this way, the smart contract is enabled to detect whether the target state variable is locked, that is, detect the target state of the target state variable.

In one embodiment of the present disclosure, when the electronic device detects that the target state of the target state variable is an unlocked state, it indicates that the target state variable is not a state variable required to be operated by the user intending to perform a transaction, in other words, there does not exist a precomputed ciphertext corresponding to the target state variable, which means that the electronic device does not store such a precomputed ciphertext. Therefore, in order to enhance the security of the smart contract, the electronic device may output prompt information indicating a transaction error for the target state variable and stop performing transaction on the target state variable.

In the step of S103, computation is performed on the privacy-trigger sub-script and the ciphertexts of the plurality of privacy-trigger sub-scripts using the preset digest algorithm to obtain the target ciphertext.

In this embodiment of the present disclosure, in order to detect whether the user intending to make transaction has the authority to perform corresponding operation on the target state variable, the electronic device may perform computation on the obtained privacy-trigger sub-script and the ciphertexts of the plurality of privacy-trigger sub-scripts using the preset digest algorithm, thereby obtaining the target ciphertext.

In some possible embodiments, the electronic device may control the smart contract execution engine to perform computation on the privacy-trigger sub-script and the ciphertexts of the plurality of privacy-trigger sub-scripts using the preset digest algorithm, thereby obtaining the target ciphertext.

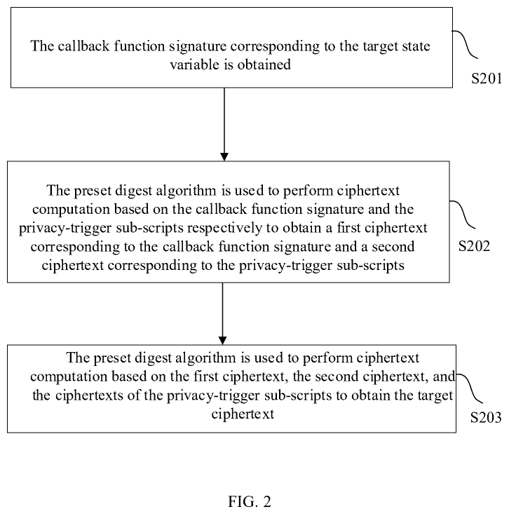

In one embodiment of the present disclosure, in order to improve the computation accuracy of the target ciphertext, the electronic device may specifically obtain the target ciphertext through computation by performing the steps S201 to S203 as shown in FIG. 2. These steps are described in detail as follows:
In the step of S201, the callback function signature corresponding to the target state variable is obtained from a storage of the electronic device.
In the step of S202, computation is performed on the callback function signature and the privacy-trigger sub-scripts respectively using the preset digest algorithm, to obtain a first ciphertext corresponding to the callback function signature and a second ciphertext corresponding to the privacy-trigger sub-scripts.
In the step of S203, computation is performed on the first ciphertext, the second ciphertext, and the ciphertexts of the privacy-trigger sub-scripts using the preset digest algorithm to obtain the target ciphertext.

In this embodiment, the electronic device pre-stores the callback function signatures for the various state variables in the smart contract. Therefore, in this case, the electronic device may obtain the callback function signature corresponding to the target state variable from a storage thereof.

It should be noted that the callback function signature is used to locate the called callback method in the smart contract.

In this embodiment, the electronic device may control the smart contract execution engine to perform computation on the callback function signature based on the preset digest algorithm, to obtain the first ciphertext corresponding to the callback function signature. The electronic device may also control the smart contract execution engine to perform computation on the privacy-trigger sub-script of the user intending to perform a transaction using the preset digest algorithm, to obtain the second ciphertext corresponding to the privacy-trigger sub-script of the user intending to perform a transaction.

Afterwards, the electronic device may control the smart contract execution engine to combine the first ciphertext, the second ciphertext, and the ciphertexts of the plurality of privacy-trigger sub-scripts to obtain first combined data.

In some possible embodiments, the first combined data may be obtained by the following combination manner: [the first ciphertext, the second ciphertext, the first privacy-trigger sub-script ciphertext, . . . , the ciphertext of the Nth privacy-trigger sub-script]. Here, N specifically refers to the total number of said other participating users.

It should be noted that the order of the ciphertexts for the plurality of privacy-trigger sub-scripts may be determined according to the actual requirement, and is not limited herein.

In this embodiment, after obtaining the first combined data, the electronic device may control the smart contract execution engine to perform computation on the first combined data using the preset digest algorithm, thereby obtaining the ciphertext corresponding to the first combined data, that is, the target ciphertext.

In the embodiments of the present disclosure, after obtaining the target ciphertext, the electronic device may compare the target ciphertext with the obtained precomputed ciphertext of the target state variable to detect whether the target ciphertext matches the precomputed ciphertext.

In one implementation manner of the embodiments of the present disclosure, the electronic device may control the smart contract execution engine to compare the target ciphertext with the obtained precomputed ciphertext of the target state variable.

In one embodiment of the present disclosure, when the electronic device may perform the steps S04-S105 when detecting that the target ciphertext is identical to the precomputed ciphertext, that is, the target ciphertext matches the precomputed ciphertext.

In another embodiment of the present disclosure, when the electronic device detects that the target ciphertext is different from the precomputed ciphertext, that is, the target ciphertext does not match the precomputed ciphertext, it indicates that the privacy-trigger sub-script input by the user intending to perform a transaction is incorrect. Therefore, the electronic device may output prompt information for informing the user intending to perform a transaction of the error in the privacy-trigger sub-script input.

In the step of S104, the decision-making script bytecode in the privacy-trigger sub-script is executed to obtain an execution result if the target ciphertext is identical to the precomputed ciphertext. The decision-making script bytecode is used to determine whether the target state variable can be unlocked.

In this embodiment of the present disclosure, when the electronic device detects that the target ciphertext is identical to the precomputed ciphertext, it indicates that the privacy-trigger sub-script input by the user intending to perform a transaction is correct, the electronic device may control the smart contract execution engine to execute the decision-making script bytecode in the privacy-trigger sub-script to obtain the execution result.

The execution results include, but are not limited to, execution success and execution failure. Execution success indicates that the privacy-trigger sub-script input by the user intending to perform a transaction meets the condition for unlocking the target state variable. Execution failure indicates that the privacy-trigger sub-script input by the user intending to perform a transaction does not meet the condition for unlocking the target state variable.

In one embodiment of the present disclosure, when the electronic device may perform the step S105 when detecting that the execution result indicates execution success.

In another embodiment of the present disclosure, when the electronic device detects that the execution result indicates execution failure, it indicates that the privacy-trigger sub-script input by the user intending to perform a transaction does not meet the condition for unlocking the target state variable. That is, the target state variable cannot be unlocked currently, which means that the user intending to perform a transaction cannot perform a corresponding operation on the target state variable. Therefore, the electronic device may output prompt information indicating that the privacy-trigger sub-script input by the user intending to perform a transaction does not meet the condition for unlocking the target state variable.

In the step of S105, a predetermined operation is performed on the target state variable in accordance with a determination that the execution result indicates execution success.

In the embodiments of the present disclosure, when the electronic device detects that the execution result is successful, it indicates that the privacy-trigger sub-script input by the user intending to perform a transaction meets the conditions for unlocking the target state variable. That is, the target state variable may be unlocked currently, which means that the user intending to perform a transaction can perform the corresponding operation on the target state variable. Therefore, the electronic device may perform the predetermined operation on the target state variable. The predetermined operation may be determined according to actual requirement, which is not limited here.

In some possible embodiments, when the target state variable is a certain digital asset, the aforesaid predetermined operation may be a digital asset transfer operation.

In one embodiment of the present disclosure, since the privacy-trigger sub-script of the user intending to perform a transaction also includes the callback method parameters, in order to improve the successful rate of execution of the target state variable and enhance user experience, the electronic device may specifically implement the step S105 by performing the following steps, which are described in detail as follows:
obtaining the callback function signature corresponding to the target state variable from the storage of the electronic device;
determining the target callback method from the smart contract according to the provided callback function signature;
executing the target callback method according to the callback method parameters to perform the predetermined operation on the target state variable.

In this embodiment, after determining that the execution result indicates execution success, the electronic device may obtain the callback function signature corresponding to the target state variable, and control the smart contract execution engine to determine the target callback method that matches the target state variable from the smart contract according to the callback function signature. Subsequently, the electronic device may control the smart contract execution engine to input the callback method parameters into the target callback method and execute the target callback method, thereby achieving performing the predetermined operation on the target state variable.

In some possible embodiments, when the predetermined operation is the digital asset transfer operation, the callback method parameters may include an account address of the user intending to perform a transaction.

From what disclosed above, it can be seen that the method for privacy protection of the smart contract provided in the embodiments of the present disclosure involves determining the target state variable corresponding to the variable identifier in the smart contract, and obtaining the precomputed ciphertext corresponding to the target state variable; performing computation on the obtained privacy-trigger sub-script and the ciphertexts of the privacy-trigger sub-script using the preset digest algorithm to obtain the target ciphertext; executing the decision-making script bytecode in the privacy-trigger sub-script to obtain the execution result if the target ciphertext is identical to the precomputed ciphertext; performing the predetermined operation on the target state variable in accordance with a determination that the execution result indicates execution success. Compared with the existing technologies, in the present disclosure, the corresponding operation may be performed on a certain state variable of the smart contract only when the privacy-trigger sub-script of the user intending to perform a transaction and the ciphertexts of the privacy-trigger sub-scripts of the other participating users meet the requirements, that is, all these privacy-trigger sub-scripts are legal. In this way, an illegitimate operation carried out by an illegitimate participant is avoided and the security of the smart contract is enhanced. Moreover, in the present disclosure, when performing unlocking operation on the state variable, the privacy-trigger sub-script of the user intending to perform a transaction is only made public, the privacy-trigger sub-scripts of said other participating users are not made public, the privacies of said other participating users are protected, and the privacy of the smart contract is enhanced accordingly. In addition, the present disclosure is not limited to consortium chains, the scope of application of the present disclosure is expanded.

In one embodiment of the present disclosure, before the step S101, in order to enhance the security of the target state variable, the owner of the target state variable may lock the target state variable, in this way, the target state variable can be unlocked and the corresponding operations can be performed on the target state variable only when the ciphertext corresponding to the information input by each participating user related to the target state variable meets the conditions (as shown in the steps S101 to S105 in FIG. 1). The participating user related to the target state variable may be determined by the owner of the target state variable.

In this embodiment, before the step S101, the electronic device may lock the target state variable by performing the following steps, which are described in detail as follows:
determining the current state of the target state variable in response to a lock command;
outputting a prompt message indicating that the target state variable cannot be locked again, in accordance with a determination that the current state of the target state variable is a locked state; or
locking the target state variable, in accordance with a determination that the current state of the target state variable is an unlocked state.

In this embodiment, a locking instruction may be sent to the electronic device when the owner of the target state variable wants to lock the target state variable.

The electronic device may determine the current state of the target state variable after detecting the locking command. The current state includes, but is not limited to, a locked state and an unlocked state.

In this embodiment, the state variable in the smart contract can only be locked one time.

Thus, when the electronic device detects that the current state of the target state variable is the locked state, it indicates that the target state variable has already been locked and cannot be locked again. Therefore, the electronic device may output a prompt message indicating that the target state variable cannot be locked again.

When the electronic device detects that the current state of the target state variable is the unlocked state, it indicates that the target state variable has never been locked. In other words, the target state variable may be locked. Therefore, the electronic device may control the smart contract execution engine to lock the target state variable.

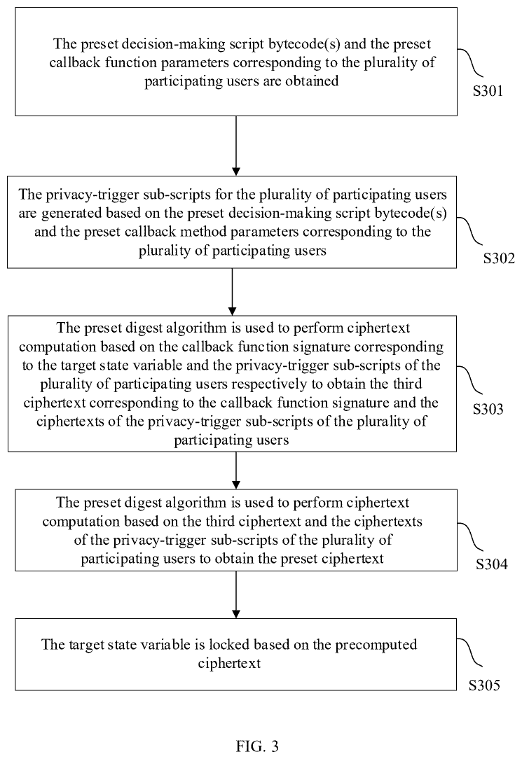

In one embodiment of the present disclosure, in order to enhance the security of the target state variable and improve the security of the smart contract, while protecting the privacy of each participating user corresponding to the target state variable and enhancing the privacy of the smart contract, the electronic device may specifically lock the target state variable by performing the steps S301 to S305 shown in FIG. 3.

On this basis, referring to FIG. 3, FIG. 3 illustrates an implementation flowchart of the method for privacy protection of the smart contract provided in another embodiment of the present disclosure. In this embodiment, the target state variable may be locked by performing steps S301 to S305 which are described in detail below:
In the step of S301, the preset decision-making script bytecode(s) and the preset callback method parameters corresponding to the plurality of participating users are obtained.

In the step of S302, the privacy-trigger sub-scripts for the plurality of participating users are generated based on the preset decision-making script bytecode(s) and the preset callback method parameters corresponding to the plurality of participating users.

In the step of S303, the preset digest algorithm is used to perform computation on the callback function signature corresponding to the target state variable and the privacy-trigger sub-scripts of the plurality of participating users respectively to obtain the third ciphertext corresponding to the callback function signature and the ciphertexts of the privacy-trigger sub-scripts of the plurality of participating users.

In the step of S304, the preset digest algorithm is used to perform computation on the third ciphertext and the ciphertexts of the privacy-trigger sub-scripts of the plurality of participating users to obtain the precomputed ciphertext.

In a step of S305, the target state variable is locked based on the precomputed ciphertext.

In this embodiment, the owner of the target state variable may compile the privacy-trigger sub-scripts corresponding to the plurality of participating users and the callback function signatures under the blockchain, thereby completing the writing of the scripts-for-privacy-triggering for the target state variable.

It should be noted that since the privacy-trigger sub-script includes the decision-making script bytecodes and the callback method parameters, the operation of writing the privacy-trigger sub-scripts corresponding to the plurality of participating users by the owner of the target state variable includes writing the decision-making script bytecodes and the callback method parameters in the plurality of privacy-trigger sub-scripts.

In this embodiment, since the owner of the target state variable compiles the privacy-trigger sub-scripts under the blockchain as described above, the owner of the target state variable may use the preset digest algorithm to perform ciphertext computation on the preset decision-making script bytecode(s) and preset callback method parameters corresponding to the plurality of participating users under the blockchain, thereby obtaining the ciphertexts of the privacy-trigger sub-scripts of the plurality of participating users. Subsequently, the owner of the target state variable may store the aforesaid ciphertexts of the privacy-trigger sub-scripts of the plurality of participating users in association with the target state variable in the blockchain.

In this embodiment, in order to obtain the final precomputed ciphertext of the target state variable, the owner of the target state variable may also use the preset digest algorithm to perform ciphertext computation on the callback function signature under the blockchain, so as to obtain the third ciphertext corresponding to the callback function signature.

Afterwards, the owner of the target state variable combines the aforesaid third ciphertext with the ciphertexts of the privacy-trigger sub-scripts of the plurality of participating users under the blockchain to obtain the second combined data.

In some possible embodiments, the second combined data may be obtained by the following combination manner: [the third ciphertext, the ciphertext of the first privacy-trigger sub-script, . . . , the ciphertext of the (N+1)-th privacy-trigger sub-script]. Here, N+1 specifically refers to the total number of all participating users.

It should be noted that the order of ciphertexts of the plurality of privacy-trigger sub-scripts may be determined according to actual requirement, which is not limited here.

In this embodiment, after obtaining the second combined data from the blockchain, the owner of the target state variable may also use the preset digest algorithm to perform ciphertext computation on this second combined data in the blockchain, thereby obtaining the ciphertext corresponding to this second combined data, that is, the precomputed ciphertext, and store this precomputed ciphertext in association with the target state variable in the electronic device.

After obtaining the precomputed ciphertext, the electronic device may lock the target state variable based on the precomputed ciphertext, in this way, the subsequent target state variable can only be unlocked when the target ciphertext is identical with the precomputed ciphertext.

In one embodiment of the present disclosure, since the owner of the target state variable compiles the privacy-trigger sub-scripts for the plurality of participating users under the blockchain and obtains the ciphertexts of the privacy-trigger sub-scripts corresponding to the plurality of participating users under the blockchain by computation, in order to enhance the level of privacy of the smart contract and protect the privacy of each participating user, for any participating user, the owner of the target state variable sends the privacy-trigger sub-script of said participating user and the ciphertexts of the privacy-trigger sub-scripts corresponding to other participating users to a terminal device of said participating user under the blockchain. Here, “other participating users” refers to all participating users except said any participating user.

On this basis, each participating user can only obtain his/her own corresponding public privacy-trigger sub-script and the ciphertexts of the privacy-trigger sub-scripts of other participating users. That is, each participating user cannot obtain the public privacy-trigger sub-scripts of other participating users.

From what described above, it can be seen that the method for privacy protection of the smart contract provided in this embodiment enhances the security of the target state variable by locking the state variable within the smart contract, thereby improving the security of the smart contract. Moreover, this method protects the privacy of each participating user corresponding to the target state variable, enhances the privacy of the smart contract, and avoids the possibility of subsequent operation of the target state variable carried out by an illegitimate participant.

The method in the present disclosure will be explained according to a specific instance. The background of this instance is introduced as follows: a system of user A has locked an asset M (i.e., the target state variable) through the smart contract, his wife B (i.e., participant user B) is allowed to withdraw the asset M at any time, his child C (i.e., Participant User C) is also allowed to withdraw the asset M after 12 months, his brother D (i.e., Participant User D) is allowed to withdraw the asset M after 10 years.

Firstly, the user A may send a locking instruction for the asset M to the electronic device.

Based on this, the user A may compile a script-for-privacy-triggering under the blockchain, the script-for-privacy-triggering includes three sub-scripts-for-privacy-triggering and a callback function signature.

The callback method parameter is an account address, and the logic of the callback method is to transfer the asset M to the aforesaid account address.

The decision-making script bytecodes recorded by the privacy-trigger sub-script 1 is used to indicate whether the account address of the current contract caller is the account address of wife B, and the parameter of the callback method is the account address of wife B. Once the conditions are met, the asset M is allowed to be transferred to the account address of wife B.

The determination-making script bytecodes recorded by the privacy-trigger sub-script 2 is used to indicate whether the account address of the current contract caller is the account address of child C, and whether the current transaction time is 12 months later than a locking time of the asset M, and the parameter of the callback method is the account address of child C. Once the conditions are met, the asset M is allowed to be transferred to the account address of child C.

The decision-making script bytecodes recorded by the privacy-trigger sub-script 3 is used to indicate whether the account address of the current contract caller is the account address of brother D, and whether the current transaction time is 10 years later than the locking time of the asset M, the parameter of the callback method is the account address of brother D. Once the conditions are met, the asset M is allowed to be transferred to the account address of brother D.

Afterwards, the electronic device may obtain the precomputed ciphertext by computation based on the callback function signature, the privacy-trigger sub-script 1, the privacy-trigger sub-script 2, and the privacy-trigger sub-script 3 mentioned above.

On this basis, the user A may construct a locked transaction, the contents of the locked transaction include the variable identifier (Key) of the locked asset M, the precomputed ciphertext of the privacy-trigger script, and the signature of the callback method.

The electronic device detects the locking instruction and processes the locking logic for the asset M through the smart contract, thereby locking the asset M.

Specifically, the electronic device may execute the target contract through the smart contract execution engine, verify whether user A is the owner of the asset M, and further verify whether the asset M is locked after the verification is passed. If the asset A is not locked, the asset M will be marked as locked, and the corresponding precomputed ciphertext and the callback function signature for the asset M will be recorded.

Afterwards, user A may distribute the respective privacy scripts to wife B, child C, and brother D.

Regarding wife B, the privacy-trigger sub-script 1 is public. User A may distribute the complete privacy-trigger sub-script 1, the ciphertext of the privacy-trigger sub-script 2, and the ciphertext of the privacy-trigger sub-script 3 to wife B.

Regarding child C, the privacy-trigger sub-script 2 is public. User A may distribute the complete privacy-trigger sub-script 2, and the ciphertext of the privacy-trigger sub-script 1 and the ciphertext of the privacy-trigger sub-script 3 to child C.

Regarding Brother D, the privacy-trigger sub-script 3 is public. User A may distribute the complete privacy-trigger sub-script 3, and the ciphertext of the privacy-trigger sub-script 1 and the ciphertext of the privacy-trigger sub-script 2 to brother D.

Six months later, when child C wants to withdraw the asset M, child C can construct a transaction instruction and send the transaction instruction to the blockchain. The transaction instruction carries a variable identifier for the asset M, the invoked privacy-trigger sub-script 2, the ciphertext of the privacy-trigger sub-script 1, and the ciphertext of the privacy-trigger sub-script 3.

In this case, the electronic device may execute the transaction through the smart contract execution engine. Specifically, after verifying that the asset M is indeed locked and the inputted privacy-trigger sub-script 2 is correct, the smart contract execution engine may start to execute the decision-making script bytecode of privacy-trigger sub-script 2. Although the account address of child C is eligible, invocation still fails because that time does not meet the conditions. Therefore, child C cannot withdraw the asset M, that is, the asset M cannot be unlocked.

When a stranger E wants to steal the asset M, stranger E constructs a transaction instruction and sends the constructed transaction instruction to the blockchain. The transaction instruction carries a variable identifier of the locked asset M, an invoked falsified privacy-trigger sub-script 1, and the ciphertexts of several falsified privacy-trigger sub-scripts.

The electronic device may execute the transaction through the smart contract execution engine. Specifically, if it is detected that the asset M is indeed locked, but the ciphertext, which is calculated from the falsified privacy-trigger sub-script 1 and the ciphertexts of several falsified privacy-trigger sub-scripts, cannot match the precomputed ciphertext of the asset M, the smart contract execution engine cannot manipulate the asset M, which causes an invocation failure, that is, the asset M cannot be unlocked, which avoids an illegitimate operation carried out by an illegitimate participant and enhances the security of the smart contract.

When wife B wants to withdraw the asset M, she can construct a transaction instruction and send the constructed transaction instruction to the blockchain. This transaction instruction carries a variable identifier for the locked asset M, the invoked privacy-trigger sub-script 1, the ciphertext of the privacy-trigger sub-script 2, and the ciphertext of the privacy-trigger sub-script 3.

The electronic device may execute the transaction through the smart contract execution engine. Specifically, when detecting that the asset M is indeed locked and the inputted privacy-trigger sub-script 1 is correct, the smart contract execution engine may begin to execute the decision-making script bytecodes of the privacy-trigger sub-script 1. Since the account address of wife B is eligible, the decision condition is met. Therefore, the smart contract execution engine may call the callback function, passing in the callback function parameter (i.e., the account address of wife B) from the privacy-trigger sub-script 1, unlock the asset M and transfer it to the account address of wife B.

In the aforementioned instance, for the transaction involving the asset M initiated by legitimate participants (such as wife B, child C, and brother D), only their respective script information will become public, while the script information of other legitimate participants remains protected. For those illegitimate participants, they are unable to obtain legitimate privacy-trigger sub-scripts, and thus cannot manipulate the asset M.

It should be understood that the sequence numbers of the steps in the above-mentioned embodiments do not indicate the order of execution. The execution order of the various processes should be determined by the functions and inherent logics of these processes, and should not construct as any limitation to the implementation process of the embodiments of the present disclosure.

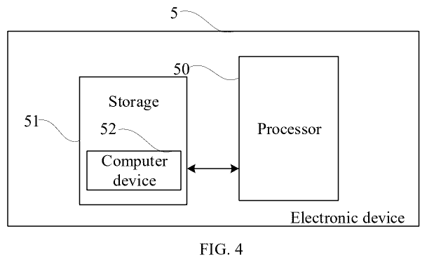

FIG. 4 is a structural schematic diagram of an electronic device 5 provided in an embodiment of the present disclosure. As shown in FIG. 4, the electronic device 5 in this embodiment includes: at least one processor 50 (only one processor is shown in FIG. 4), a storage 51, and a computer program 52 stored in the storage 51 and executable by the at least one processor 50. When the processor 50 is configured to, when executing the computer program 52, implement the steps in in any one of the method embodiments for privacy protection of the smart contract.

The electronic device 5 may include, but is not limited to, a processor 50, a storage 51. A person of ordinary skill in the art may understand that, FIG. 4 is only one example of the electronic device 5, but should not be constituted as limitation to the electronic device 5, more or less components than the components shown in FIG. 4 may be included, or alternatively, some components or different components may be combined. For example, the electronic device 5 may also include an input and output device, a network access device, etc.

The so-called processor 50 may be central processing unit (Central Processing Unit, CPU), and may also be other general purpose processor, digital signal processor (Digital Signal Processor, DSP), application specific integrated circuit (Application Specific Integrated Circuit, ASIC), field-programmable gate array (Field-Programmable Gate Array, FPGA), or some other programmable logic devices, discrete gate or transistor logic device, discrete hardware component, etc. The general purpose processor may be a microprocessor, as an alternative, the processor can also be any conventional processor, etc.

The storage 51 may be an internal storage unit of the electronic device 5, such as a memory of the electronic device 5. The storage 51 may also be an external storage device of the electronic device 5, such as a plug-in hard disk, a smart media card (Smart Media Card, SMC), a secure digital (Secure Digital, SD) card, a flash card (Flash Card, FC) equipped on the electronic device 5. Furthermore, the storage 51 may not only include the internal storage unit of the electronic device 5, but also include the external memory of the electronic device 5. The storage 51 is configured to store an operating system, an application program, a BootLoader, data and other procedures, such as program codes of the computer program, etc. The storage 51 may also be configured to temporarily store data that has been output or being ready to be output.

A non-transitory computer-readable storage medium is further provided in the embodiments of the present disclosure, the computer-readable storage medium stores a computer program,, that, when executed by a processor, implements the steps in the aforesaid various method embodiments.

A computer program product is provided in the embodiments of the present disclosure. The computer program product is configured to, when executed on the electronic device, causes the electronic device to implement the steps in the aforesaid various method embodiments.

When the integrated unit is achieved in the form of software functional units, and is sold or used as an independent product, the integrated unit may be stored in a computer readable storage medium. Based on this understanding, a whole or part of flow process for implementing the method in the embodiments of the present disclosure may also be accomplished in the manner of using computer program to instruct relevant hardware. When the computer program is executed by the processor, the steps in the various method embodiments described above may be implemented. The computer program includes computer program codes, which may be in the form of source code, object code, executable documents or some intermediate form, etc.

In the aforesaid embodiments, the descriptions of the various embodiments are emphasized respectively. Regarding a part of one embodiment which has not been described or disclosed in detail, reference can be made to relevant descriptions in other embodiments.

The foregoing embodiments are only intended to explain the technical solutions of the present disclosure, rather than limiting the technical solutions of the present disclosure. Although the present disclosure has been described in detail with reference to these embodiments, a person of ordinary skilled in the art should understand that, the technical solutions disclosed in the embodiments may also be amended, some technical features in the technical solutions may also be equivalently replaced. The amendments or the equivalent replacements don't cause the essence of the corresponding technical solutions to be deviated from the spirit and the scope of the technical solutions in the embodiments of the present disclosure, and thus should all be included in the protection scope of the present disclosure.

What is claimed is:

1. A method for privacy protection of a smart contract implemented by a node device within a blockchain, comprising:
obtaining, in response to receiving a transaction instruction from a user intending to perform a transaction, a variable identifier, a privacy-trigger sub-script, and ciphertexts of a plurality of privacy-trigger sub-scripts of other participating users input by the user intending to perform a transaction; wherein the privacy-trigger sub-script is used for unlocking a corresponding state variable in the smart contract;
determining a target state variable corresponding to the variable identifier in the smart contract, and obtaining a precomputed ciphertext corresponding to the target state variable; wherein the precomputed ciphertext is calculated by using a preset digest algorithm;
computing, using the preset digest algorithm, based on the plurality of privacy-trigger sub-scripts and the ciphertexts of the plurality of privacy-trigger sub-scripts to obtain a target ciphertext;
executing, in accordance with a determination that the target ciphertext is identical to the precomputed ciphertext, a decision-making script bytecode in the privacy-trigger sub-script to obtain an execution result; wherein the decision-making script bytecode is used to determine whether the target state variable can be unlocked; and
performing a predetermined operation on the target state variable in accordance with a determination that the execution result indicates execution success;
wherein said computing, using the preset digest algorithm, based on the plurality of privacy-trigger sub-scripts and the ciphertexts of the plurality of privacy-trigger sub-scripts to obtain the target ciphertext comprises:
obtaining a callback function signature corresponding to the target state variable from a storage of the node device;
computing, using the preset digest algorithm, based on the callback function signature and the privacy-trigger sub-script respectively to obtain a first ciphertext corresponding to the callback function signature and a second ciphertext corresponding to the privacy-trigger sub-script; and
computing, using the preset digest algorithm, based on the first ciphertext, the second ciphertext, and the ciphertexts of the plurality of privacy-trigger sub-scripts to obtain the target ciphertext.

2. The method for privacy protection of the smart contract according to claim 1, wherein said obtaining the precomputed ciphertext corresponding to the target state variable comprises:
determining a target state of the target state variable; and
obtaining the precomputed ciphertext in accordance with a determination that the target state is a locked state.

3. The method for privacy protection of the smart contract according to claim 1, wherein the privacy-trigger sub-script comprises callback method parameters; said performing the predetermined operation on the target state variable comprises:
obtaining a callback function signature corresponding to the target state variable from a storage of the node device;
controlling a smart contract execution engine to determine a target callback method matching the callback function signature in the smart contract; and
controlling the smart contract execution engine to execute the target callback method according to the callback method parameters to implement performing the predetermined operation on the target state variable.

4. The method for privacy protection of the smart contract according to claim 1, wherein before said obtaining, in response to receiving the transaction instruction from the user intending to perform a transaction, the variable identifier, the privacy-trigger sub-script, and the ciphertexts of the plurality of privacy-trigger sub-scripts of other participating users input by the user intending to perform a transaction, the method further comprises:
determining a current state of the target state variable in response to receiving a locking instruction from an owner of the target state variable;
outputting a prompt message indicating that the target state variable cannot be locked again, in accordance with a determination that the current state of the target state variable is a locked state; or alternatively,
locking the target state variable in accordance with a determination that the current state of the target state variable is an unlocked state.

5. The method for privacy protection of the smart contract according to claim 4, wherein said locking the target state variable comprises:
obtaining preset decision-making script bytecode(s) and preset callback method parameters corresponding to a plurality of participating users;
generating the privacy-trigger sub-scripts for the plurality of participating users based on the preset decision-making script bytecode(s) and the preset callback method parameters corresponding to the plurality of participating users;
computing, using the preset digest algorithm, based on the callback function signature corresponding to the target state variable and the privacy-trigger sub-scripts of the plurality of participating users respectively, to obtain a third ciphertext corresponding to the callback function signature and the ciphertexts of the privacy-trigger sub-scripts of the plurality of participating users;
computing, using the preset digest algorithm, based on the third ciphertext and the ciphertexts of the privacy-trigger sub-scripts of the plurality of participating users to obtain the precomputed ciphertext; and
locking the target state variable based on the precomputed ciphertext.

6. The method for privacy protection of the smart contract according to claim 5, wherein after said locking the target state variable based on the precomputed ciphertext, the method further comprises:
sending, for any participating user, the privacy-trigger sub-script of the any participating user and the ciphertexts of the privacy-trigger sub-scripts corresponding to other participating users to a terminal device of the participating user; wherein said other participating users refer to all other users except the participating user among the plurality of participating users.

7. An electronic device, comprising a processor, a storage, and a computer program stored in the storage and executable by the processor, wherein the processor is configured to, when executing the computer program, cause the electronic device to implement privacy protection operations for a smart contract, comprising:
obtaining, in response to receiving a transaction instruction from a user intending to perform a transaction, a variable identifier, a privacy-trigger sub-script, and ciphertexts of a plurality of privacy-trigger sub-scripts of other participating users input by the user intending to perform a transaction; wherein the privacy-trigger sub-script is used for unlocking a corresponding state variable in the smart contract;
determining a target state variable corresponding to the variable identifier in the smart contract, and obtaining a precomputed ciphertext corresponding to the target state variable; wherein the precomputed ciphertext is calculated by using a preset digest algorithm;
computing, using the preset digest algorithm, based on the plurality of privacy-trigger sub-scripts and the ciphertexts of the plurality of privacy-trigger sub-scripts to obtain a target ciphertext;
executing, in accordance with a determination that the target ciphertext is identical to the precomputed ciphertext, a decision-making script bytecode in the privacy-trigger sub-script to obtain an execution result; wherein the decision-making script bytecode is used to determine whether the target state variable can be unlocked; and
performing a predetermined operation on the target state variable in accordance with a determination that the execution result indicates execution success;
wherein said computing, using the preset digest algorithm, based on the plurality of privacy-trigger sub-scripts and the ciphertexts of the plurality of privacy-trigger sub-scripts to obtain the target ciphertext comprises:
obtaining a callback function signature corresponding to the target state variable from a storage of a node device;
computing, using the preset digest algorithm, based on the callback function signature and the privacy-trigger sub-script respectively to obtain a first ciphertext corresponding to the callback function signature and a second ciphertext corresponding to the privacy-trigger sub-script; and
computing, using the preset digest algorithm, based on the first ciphertext, the second ciphertext, and the ciphertexts of the plurality of privacy-trigger sub-scripts to obtain the target ciphertext.

8. A computer program product, comprising a computer program, that, when executed by a processor of an electronic device, causes the processor of the electronic device to implement privacy protection operations for a smart contract, comprising:
obtaining, in response to receiving a transaction instruction from a user intending to perform a transaction, a variable identifier, a privacy-trigger sub-script, and ciphertexts of a plurality of privacy-trigger sub-scripts of other participating users input by the user intending to perform a transaction; wherein the privacy-trigger sub-script is used for unlocking a corresponding state variable in the smart contract;
determining a target state variable corresponding to the variable identifier in the smart contract, and obtaining a precomputed ciphertext corresponding to the target state variable; wherein the precomputed ciphertext is calculated by using a preset digest algorithm;
computing, using the preset digest algorithm, based on the plurality of privacy-trigger sub-scripts and the ciphertexts of the plurality of privacy-trigger sub-scripts to obtain a target ciphertext;
executing, in accordance with a determination that the target ciphertext is identical to the precomputed ciphertext, a decision-making script bytecode in the privacy-trigger sub-script to obtain an execution result; wherein the decision-making script bytecode is used to determine whether the target state variable can be unlocked; and
performing a predetermined operation on the target state variable in accordance with a determination that the execution result indicates execution success;
wherein the computer program is further configured to cause the processor of the electronic device to implement the operation of computing, using the preset digest algorithm, based on the plurality of privacy-trigger sub-scripts and the ciphertexts of the plurality of privacy-trigger sub-scripts to obtain the target ciphertext by:
obtaining a callback function signature corresponding to the target state variable from a storage of a node device;
computing, using the preset digest algorithm, based on the callback function signature and the privacy-trigger sub-script respectively to obtain a first ciphertext corresponding to the callback function signature and a second ciphertext corresponding to the privacy-trigger sub-script; and
computing, using the preset digest algorithm, based on the first ciphertext, the second ciphertext, and the ciphertexts of the plurality of privacy-trigger sub-scripts to obtain the target ciphertext.

9. The electronic device according to claim 7, wherein the processor is further configured to implement the operation of computing, using the preset digest algorithm, based on the first ciphertext, the second ciphertext, and the ciphertexts of the plurality of privacy-trigger sub-scripts to obtain the target ciphertext by:
controlling a smart contract execution engine to combine the first ciphertext, the second ciphertext, and the ciphertexts of the plurality of privacy-trigger sub-scripts to obtain first combined data; and
controlling the smart contract execution engine to perform computation on the first combined data using the preset digest algorithm to obtain the target ciphertext corresponding to the first combined data.

10. The electronic device according to claim 7, wherein the processor is further configured to implement the operation of obtaining the precomputed ciphertext corresponding to the target state variable by:
determining a target state of the target state variable; and
obtaining the precomputed ciphertext in accordance with a determination that the target state is a locked state.

11. The electronic device according to claim 7, wherein the privacy-trigger sub-script comprises callback method parameters; the processor is further configured to implement the operation of performing the predetermined operation on the target state variable by:
obtaining a callback function signature corresponding to the target state variable from a storage of the node device;
controlling a smart contract execution engine to determine a target call method matching the callback function signature in the smart contract; and
controlling the smart contract execution engine to execute a target callback method according to the callback method parameters to implement performing the predetermined operation on the target state variable.

12. The electronic device according to claim 7, wherein before the operation of obtaining, in response to receiving the transaction instruction from the user intending to perform a transaction, the variable identifier, the privacy-trigger sub-script, and the ciphertexts of the plurality of privacy-trigger sub-scripts of other participating users input by the user intending to perform a transaction, the processor is further configured to implement following operations:
determining a current state of the target state variable in response to receiving a locking instruction from an owner of the target state variable;
outputting a prompt message indicating that the target state variable cannot be locked again, in accordance with a determination that the current state of the target state variable is a locked state; or alternatively,
locking the target state variable in accordance with a determination that the current state of the target state variable is an unlocked state.

13. The electronic device according to claim 12, wherein the processor is configured to implement the operation of locking the target state variable by:
obtaining preset decision-making script bytecode(s) and preset callback method parameters corresponding to a plurality of participating users;
generating the privacy-trigger sub-scripts for the plurality of participating users based on the preset decision-making script bytecode(s) and the preset callback method parameters corresponding to the plurality of participating users;
computing, using the preset digest algorithm, based on the callback function signature corresponding to the target state variable and the privacy-trigger sub-scripts of the plurality of participating users respectively, to obtain a third ciphertext corresponding to the callback function signature and the ciphertexts of the privacy-trigger sub-scripts of the plurality of participating user;
computing, using the preset digest algorithm, based on the third ciphertext and the ciphertexts of the privacy-trigger sub-scripts of the plurality of participating users to obtain the precomputed ciphertext; and
locking the target state variable based on the precomputed ciphertext.

14. The electronic device according to claim 13, wherein after the operation of locking the target state variable based on the precomputed ciphertext, the processor is further configured to perform following operations:
sending, for any participating user, the privacy-trigger sub-script of the any participating user and the ciphertexts of the privacy-trigger sub-scripts corresponding to other participating users to a terminal device of the participating user; wherein said other participating users refer to all other users except the participating user among the plurality of participating users.

15. The electronic device according to claim 13, wherein the processor is further configured to implement the operation of computing, using the preset digest algorithm, based on the third ciphertext and the ciphertexts of the privacy-trigger sub-scripts of the plurality of participating users to obtain the precomputed ciphertext by:
combining the third ciphertext with the ciphertexts of the privacy-trigger sub-scripts of the plurality of participating users under a blockchain to obtain second combined data; and
computing, using the preset digest algorithm, based on the second combined data in the blockchain to obtain the precomputed ciphertext corresponding to the second combined data.

16. The computer program product according to claim 8, wherein the computer program is further configured to cause the processor of the electronic device to implement the operation of obtaining the precomputed ciphertext corresponding to the target state variable by:
determining a target state of the target state variable; and
obtaining the precomputed ciphertext in accordance with a determination that the target state is a locked state.

17. The computer program product according to claim 8, wherein the privacy-trigger sub-script comprises callback method parameters; the computer program is further configured to cause the processor of the electronic device to implement the operation of performing the predetermined operation on the target state variable by:
obtaining a callback function signature corresponding to the target state variable from a storage of the node device;
controlling a smart contract execution engine to determine a target call method matching the callback function signature in the smart contract; and
controlling the smart contract execution engine to execute a target callback method according to the callback method parameters to implement performing the predetermined operation on the target state variable.

18. The computer program product according to claim 8, wherein before the operation of obtaining, in response to receiving the transaction instruction from the user intending to perform a transaction, the variable identifier, the privacy-trigger sub-script, and the ciphertexts of the plurality of privacy-trigger sub-scripts of other participating users input by the user intending to perform a transaction, the computer program is further configured to cause the processor of the electronic device to implement following operations:
determining a current state of the target state variable in response to receiving a locking instruction from an owner of the target state variable;
outputting a prompt message indicating that the target state variable cannot be locked again, in accordance with a determination that the current state of the target state variable is a locked state; or alternatively,
locking the target state variable in accordance with a determination that the current state of the target state variable is an unlocked state.

19. The computer program product according to claim 18, wherein the computer program is further configured to cause the processor of the electronic device to implement the operation of locking the target state variable by:
obtaining preset decision-making script bytecode(s) and preset callback method parameters corresponding to a plurality of participating users;
generating the privacy-trigger sub-scripts for the plurality of participating users based on the preset decision-making script bytecode(s) and the preset callback method parameters corresponding to the plurality of participating users;
computing, using the preset digest algorithm, based on the callback function signature corresponding to the target state variable and the privacy-trigger sub-scripts of the plurality of participating users respectively, to obtain a third ciphertext corresponding to the callback function signature and the ciphertexts of the privacy-trigger sub-scripts of the plurality of participating user;
computing, using the preset digest algorithm, based on the third ciphertext and the ciphertexts of the privacy-trigger sub-scripts of the plurality of participating users to obtain the precomputed ciphertext; and
locking the target state variable based on the precomputed ciphertext.

20. The computer program product according to claim 19, wherein after the operation of locking the target state variable based on the precomputed ciphertext, the computer program is further configured to cause the processor of the electronic device to implement the operation of locking the target state variable by:
sending, for any participating user, the privacy-trigger sub-script of the any participating user and the ciphertexts of the privacy-trigger sub-scripts corresponding to other participating users to a terminal device of the participating user; wherein said other participating users refer to all other users except the participating user among the plurality of participating users.
